(19) United States
(12) Patent Application Publication
(10) Pub. No.: US 2015/0002036 A1
(43) Pub. Date: Jan. 1, 2015

(54) Triac Dimmable LED Driver Circuit

(71) Applicant: Shanghai Bright Power Semiconductor Co., Ltd., Shanghai (CN)

(72) Inventors: Shungen Sun, Shanghai (CN); Liqiang Hu, Shanghai (CN)

(73) Assignee: SHANGHAI BRIGHT POWER SEMICONDUCTOR CO., LTD., Shanghai (CN)

(21) Appl. No.: 13/970,734

(22) Filed: Aug. 20, 2013

(30) Foreign Application Priority Data
Jun. 26, 2013 (CN) 201310257527.8

(51) Int. Cl. H05B 33/08

(52) U.S. Cl. CPC H05B 33/0809
USPC 315/200 R

(57) ABSTRACT

A TRIAC dimmable light-emitting diode (LED) driver circuit is disclosed, compromising: An alternating-current (AC) voltage connected to a rectifier bridge; An LED load, which is connected to an inductor or a transformer, a power MOS transistor, a low voltage MOS transistor and a current sensing resistor. The LED driver also compromises: a peak current comparator which is used to compare the voltage between a current sensing resistor and a reference voltage; a maximum on-time timer, which is used to detect the on time of the low voltage MOS transistor. When the voltage on the current sensing resistor is higher than the reference voltage or the on time of the low voltage MOS transistor reaches the preset time of the maximum on-time timer, the low voltage MOS transistor is turned off.

### CROSS-REFERENCE TO RELATED DOCUMENT

The present application claims priority from CN 201310257527.8 filed on Jun. 26, 2013, the disclosure of which is hereby incorporated herein by reference.

### FIELD OF THE INVENTION

The present invention relates generally to Light-Emitting Diode (“LED”) driver circuits, and in particular, to TRIAC dimmable LED driver circuits.

### BACKGROUND OF THE INVENTION

FIG. 1 (Prior Art) is a diagram of a conventional TRIAC dimmable LED driver. As shown in FIG. 1, an alternating-current (AC) voltage source 101 is in series with a TRIAC dimmer 102, and is connected to the input terminal of a diode bridge 103. The diode bridge 103 rectifies the input AC voltage and generates a sinusoidal voltage on capacitor C1. Resistor R4 and capacitor C2 generates a DC voltage to start up the control IC 104.

The transformer T1 has three windings, including a primary winding connected with capacitor C1 and the drain of the power M1, a secondary winding connected with a rectifying diode D1 and a secondary output capacitor C4, and an auxiliary winding connected with a supplying diode D2 and the circuit ground.

After the circuit starts up, the auxiliary winding powers up the control IC 104. At the same time, the auxiliary winding provides the rectifier diode D1 zero-crossing current information and the output over voltage information.

The prior art usually contains a resistor divider R2 and R3, which is used to detect the TRIAC phase cutting angle.

The prior art also contains a bleeding resistor R1 and a bleeding switch M2 . When the input current of the flyback converter is small, the control IC 104 turns on the bleeding switch M2, providing enough holding current for the TRIAC dimmer.

The prior art has the following disadvantages:

First, the bleeding resistor R1 and bleeding switch M2 dissipate too much power, losing the LED driver efficiency and inducing too much heat . The LED driver suffers from high temperature and low reliability.

Second, the control circuit is complex, and the system cost is relatively high.

### SUMMARY OF THE INVENTION

The present invention has been developed to solve the problems of the prior art. The present invention provides a TRIAC dimmable LED driver circuit which can eliminate the bleeder circuit and reduce system complexity and cost.

To achieve the above-mentioned object, the present invention discloses a TRIAC dimmable LED driver circuit. An input AC voltage source is connected to a rectifier bridge and an LED load. The LED load is connected to an inductor or a transformer, a power MOS transistor, a low voltage MOS transistor and a current sensing resistor. A peak current comparator is used to compare the voltage between a current sensing resistor and a reference voltage. A maximum on-time timer is used to detect the on time of the low voltage MOS transistor.

When the voltage on the current sensing resistor is higher than the reference voltage or the on time of the low voltage MOS transistor reaches the preset time of the maximum on-time timer, the low voltage MOS transistor is turned off.

Furthermore, one input terminal of the peak current comparator is connected to the current sensing resistor, another input terminal is connected to the reference voltage.

Furthermore, the LED driver circuit includes an OR logic gate and a RS flip-flop. The input signal of the maximum on-time timer is connected to the output of the RS flip-flop. The input signal of the OR logic gate is connected to the output of the maximum on-time timer and the output of the peak current comparator. The output signal of the OR logic gate is connected to the reset terminal of the RS flip-flop.

Furthermore, the LED driver circuit includes a first voltage sensing network, a second voltage sensing network and a demagnetization comparator. The input terminal of the first voltage sensing network is connected to the gate of the power MOS transistor . The input terminal of the second voltage sensing network is connected to the source of the power MOS transistor. The output of the first voltage sensing network and the second voltage sensing network are connected to the input terminals of the demagnetization comparator. The output of the demagnetization comparator is connected to the reset terminal of the RS flip-flop. The first voltage sensing network is composed of resistors and capacitors, and the second voltage sensing network is also composed of resistors and capacitors.

Furthermore, the LED driver includes a switch driver. The input terminal of the switch driver is connected to the output of the RS flip-flop, and the output of the switch driver is connected to the gate of the low voltage MOS transistor.

Furthermore, the inductor or the transformer includes at least two windings. The first winding is connected to the power MOS transistor, and the auxiliary winding is connected to the positive terminal of a supplying diode. The negative terminal of the supplying diode is connected to a supplying capacitor.

Furthermore, the LED driver further includes two resistors and an over voltage protection circuit. The resistors are in series and are connected to the auxiliary winding of the inductor or transformer. The middle point of the resistors is connected to the over voltage protection circuit.

Furthermore, the supplying capacitor is paralleled with a zener diode.

Furthermore, the LED driver is a buck-boost TRIAC dimmable LED driver, or a buck TRIAC dimmable LED driver, or a flyback TRIAC dimmable LED driver.

Compared with the prior art, the TRIAC dimmable LED driver circuit eliminates the bleeder circuit and utilizes the converter input current to provide the holding current for the TRIAC dimmer. Meanwhile, the driver circuit drives the source of the power MOS transistor and greatly reduces the driving current of the power. A simple, efficient and widely compatible TRIAC dimmable LED driver is realized.

### BRIEF DESCRIPTION OF THE DRAWINGS

The advantage and spirit of the invention can be understood by the following recitations together with the appended drawings.

FIG. 1 is a circuit diagram of one TRIAC dimmable LED driver circuit in the prior art.

FIG. 2 is a circuit diagram of a buck-boost TRIAC dimmable LED driver circuit illustrated in the present invention.

FIG. 3 is a typical waveform diagram that illustrates the operation of the TRIAC dimmable LED driver circuit illustrated in the present invention.

FIG. 4 is a typical waveform diagram that illustrates the dimming operation of the TRIAC dimmable LED driver circuit illustrated in the present invention.

FIG. 5 is a circuit diagram of a buck TRIAC dimmable LED driver circuit illustrated in the present invention.

FIG. 6 is a circuit diagram of a flyback TRIAC dimmable LED driver circuit illustrated in the present invention.

### DETAILED DESCRIPTION

The embodiments according to the invention are hereinafter described with reference to the drawings.

For solving the problem that the power dissipation problem of the bleeder circuit and complexity of the LED driver circuit in the prior art, the present invention discloses a TRIAC dimmable LED driver circuit. The TRIAC dimmable LED driver circuit eliminates the bleeder circuit and utilizes the input current of the converter to provide the holding current for the TRIAC dimmer. Meanwhile, the driver circuit drives the source of the power MOS transistor and greatly reduces the driving current of the power. A simple, efficient and widely compatible TRIAC dimmable LED driver is realized.

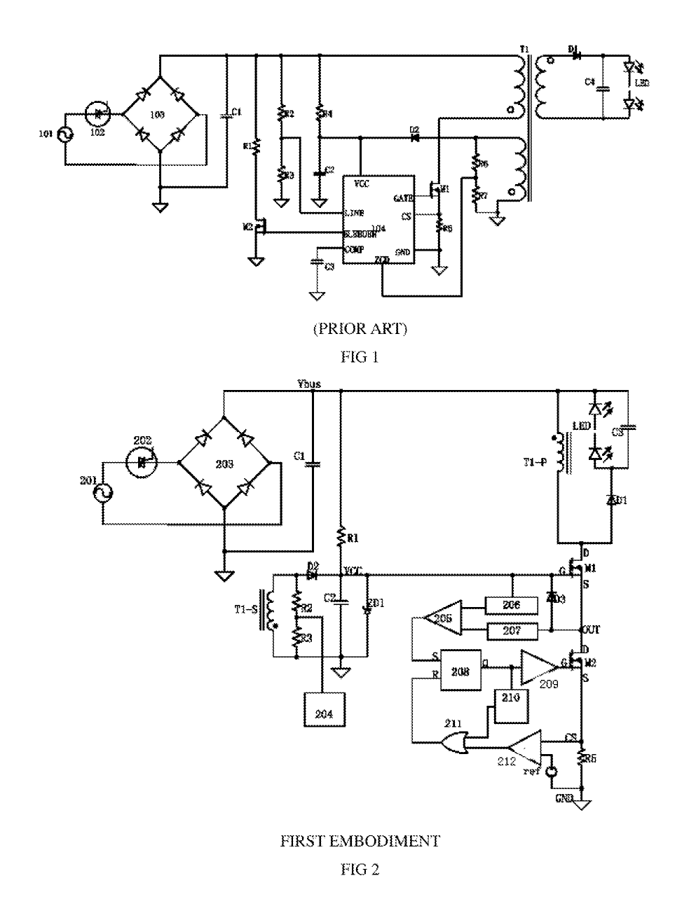

The TRIAC dimmable LED driver illustrated in the present invention improves the driving method and control scheme of the prior art. FIG. 2 is a circuit diagram of a TRIAC dimmable LED driver circuit illustrated in the present invention. An input AC voltage source 201 provides power for the LED driver circuit. The AC source 201 is in series with a TRIAC dimmer 202. The conduction angle of the TRIAC dimmer 202 can be adjusted, thereby the brightness of the LED lamp should vary accordingly.

The output of the TRIAC dimmer 202 is connected to a rectifier bridge 203. The rectifier bridge 203 converts the sinusoidal input AC voltage to a positive voltage signal Vbus. A bus capacitor C1 is connected to the output of the rectifier bridge 203 and provides a high frequency current path for the converter.

The first winding T1-P of the inductor T1 is connected between the bus capacitor C1 and the drain of the power MOS transistor. The positive terminal of a rectifying diode D1 is connected to the drain of the power MOS transistor, and the negative terminal of the rectifying diode D1 is connected to an output capacitor C3 and LED load. The output capacitor C3 is paralleled with the LED load and connected to Vbus.

The inductor T1 stores energy when the power MOS transistor M1 is turned on. And the energy is released to the output capacitor C3 and LED load through the rectifying diode D1 when the power MOS transistor M1 is turned off.

The TRIAC dimmable LED driver utilizes a source driving scheme. A low voltage MOS transistor M2 is in series with the power MOS transistor M1. The drain D of the low voltage MOS transistor M2 is connected to the source S of the power MOS transistor M1. When the low voltage MOS transistor M2 is turned on, the power MOS transistor M1 is also turned on. When the low voltage MOS transistor M2 is turned off, the power MOS transistor M1 is also turned off.

A supplying resistor R1 provides the start up current for the LED driver circuit. One terminal of the supplying resistor R1 is connected to Vbus, another terminal is connected to a supplying capacitor C1, and the other terminal of the supplying capacitor C1 is grounded. The voltage signal on the supplying capacitor C1 is VCC signal. The gate G of the power MOS transistor M1 is connected to VCC. The source S of the power MOS transistor M1 is connected to VCC through a feeding diode D3.

The TRIAC dimmable LED driver circuit further includes two voltage sensing networks. The input of the first voltage sensing network 206 is connected to VCC, and the output of the first voltage sensing network 206 is connected to one of the input terminal of a demagnetization comparator 205. The input of the second voltage sensing network 207 is connected to the source of the power MOS transistor M1, and the output of the second voltage sensing network 207 is connected to the other input terminal of the demagnetization comparator 205. The output of the demagnetization comparator 205 is connected to the reset terminal S of a RS flip-flop 208. The first voltage sensing network 206 and the second voltage sensing network 207 could be the combination of resistor and resistor, capacitor and capacitor, or resistor and capacitor.

The source of the low voltage MOS transistor M2 is connected to a current sensing resistor R5. The current in the current sensing resistor R5 is same as the current in the first winding T1-P of the inductor T1. The voltage on the current sensing resistor R5 is CS signal. The CS signal is connected to one input terminal of the current comparator 212, the other input terminal of the current comparator 212 is connected to a reference voltage ref. The output of the current comparator 212 is connected to one of the input terminals of an OR logic gate 211.

The output Q of the RS flip-flop 208 is connected to the input terminal of a switch driver circuit 209. The output of the switch driver circuit 209 is connected to the gate of the low voltage MOS transistor M2. The output Q of the RS flip-flop 208 is also connected to a maximum on-time timer 210. The output of the maximum on-time timer is connected to one of the input terminals of the OR logic gate 211. The output of the OR logic gate 211 is connected to the reset terminal R of the RS flip-flop 208.

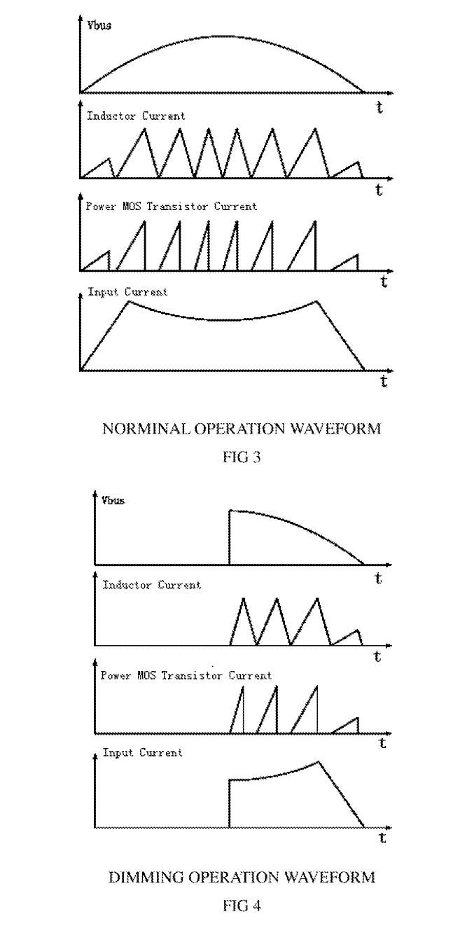

FIG. 3 is a typical waveform diagram that illustrates the operation of the TRIAC dimmable LED driver circuit illustrated in the present invention.

When the low voltage MOS transistor M2 is turned on, the power MOS transistor M1 is also turned on. The voltage across the first winding T1-P of the inductor T1 is equal to Vbus. The current in the first winding T1-P increases, and the voltage on the current sensing resistor R5 also increases.

When the voltage on the current sensing resistor R5 reaches the reference voltage ref, the output of the current comparator 212 is changed high, the output of the OR logic gate 211 is also changed high and the RS flip-flop resets. The switch driver circuit 209 turns off the low voltage MOS transistor M2 at the same time the power MOS transistor M1 is also turned off.

Meanwhile, the rectifying diode D1 starts conducting current. The voltage across the first winding T1-P of the inductor T1 is equal to the output capacitor C3 voltage, and the current in the first winding T1-P decreases. When the current in the rectifying diode D1 reaches zero, the drain voltage of the power MOS transistor M1 starts decreasing. Because of the capacitive coupling between drain and source of M1, the source voltage of the power MOS transistor M1 also starts decreasing. At this time, the demagnetization comparator 205 compares the output voltage of the first voltage sensing network 206 and the second voltage sensing network 207, and the demagnetization comparator 205 is changed high. The RS flip-flop 208 is set, the switch driving circuit 209 turns on the low voltage MOS transistor M2, and the power MOS transistor M1 is also turned on, the next switching cycle is started.

The maximum on-time timer 210 detects the on time of the low voltage MOS transistor M2. When the on time of the low voltage MOS transistor M2 is longer than the system preset value, the maximum on-time timer 210 outputs a signal to the OR logic gate 211, the RS flip-flop 208 is reset and the switch driver circuit 209 turns off the low voltage MOS transistor M2.

As shown in FIG. 3, the circuit works in quasi-resonant mode, when Vbus voltage is relatively high, the peak inductor current is determined by the reference voltage ref and the current sensing resistor R5. When Vbus voltage is relatively low, the maximum on-time time 210 takes action, the peak inductor current is determined by the Vbus voltage and the preset on time. The current of the power MOS transistor M1 is filtered by the bus capacitor C1, and the system input current waveform is sketched in FIG. 3.

FIG. 4 is a typical waveform diagram that illustrates the dimming operation of the TRIAC dimmable LED driver circuit illustrated in the present invention.

When the lamp is dimmed by the TRIAC dimmer 202, the conduction angle of the TRIAC dimmer 202 is adjusted. When the TRIAC dimmer 202 blocks the input voltage, Vbus voltage is nearly zero, and the current in inductor T1 is also zero. When the TRIAC dimmer 202 conducts, Vbus voltage is equal to the input voltage, the LED driver delivers power to the output capacitor C3 and the LED load. With difference conduction angle of the TRIAC dimmer 202, the power in the LED load is adjusted, and the dimming function is achieved.

The auxiliary winding T1-S of the inductor T1 is connected to VCC through a supplying diode D2. Before the LED driver circuit starts up, the supplying resistor R1 charges the supplying capacitor C1 up, and the VCC voltage increases. When the VCC voltage reaches a starting up threshold, the LED driver circuit starts working, and the auxiliary winding T1-S powers up the VCC through the supplying diode D2.

The present invention further includes an over voltage protection circuit. Dividing resistors R2 and R3 is in series and connected to the auxiliary winding T1-S, the middle point of the resistors is connected to the input terminal of the over voltage protection circuit 204. When the rectifying diode D1 conducts, the auxiliary winding voltage is proportional to the voltage across the LED load. When the LED load is open circuit, the voltage of the output capacitor C3 increases, and also the auxiliary winding T1-S voltage. If the input terminal of the over voltage protection circuit 204 is higher than a preset value, the output over voltage condition is detected, and the low voltage MOS transistor is turned off.

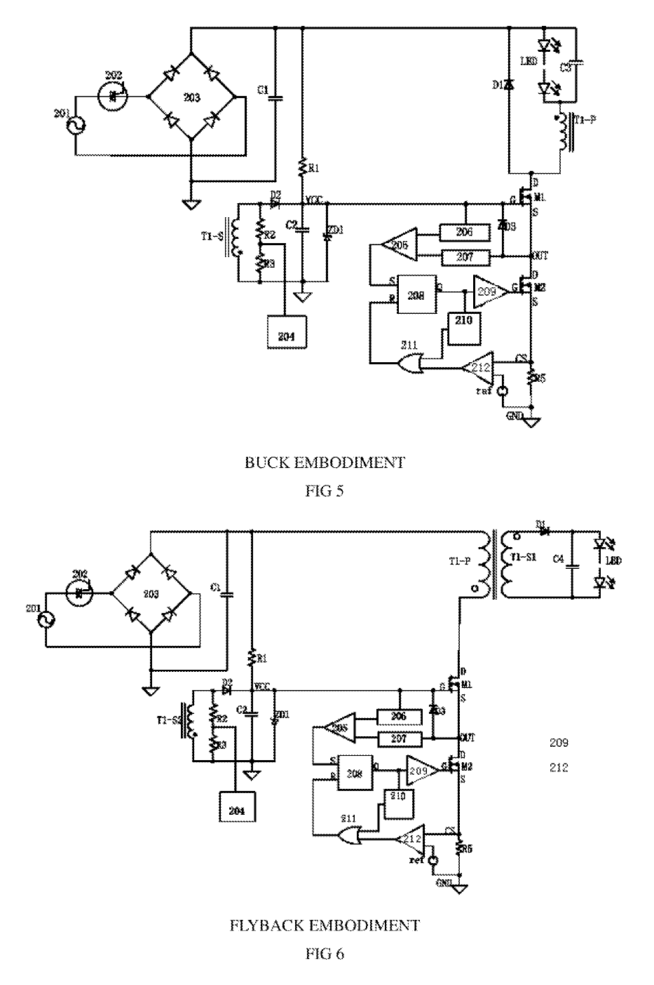

The present invention of the TRIAC dimmable LED driver circuit can be also implemented with the buck topology, as shown in FIG. 5. The driving method and control scheme of the buck topology implementation is similar with that of the buck-boost implementation and is not repeated here.

The present invention of the TRIAC dimmable LED driver circuit can be also implemented with the flyback topology, as shown in FIG. 6. The driving method and control scheme of the flyback topology implementation is similar with that of the buck-boost implementation and is not repeated here.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A TRIAC dimmable LED driver circuit comprises an input AC voltage source connected to a rectifier bridge and an LED load, the LED load is connected to an inductor or a transformer, a power MOS transistor, a low voltage MOS transistor and a current sensing resistor, the LED driver is characterized in that,
a peak current comparator, which is used to compare the voltage between the current sensing resistor and a reference voltage;
a maximum on-time timer, which is used to detect the on time of the low voltage MOS transistor,
when the voltage on the current sensing resistor is higher than the reference voltage, or the on time of the low voltage MOS transistor reaches the preset time of the maximum on-time timer, the low voltage MOS transistor is turned off.

2. The TRIAC dimmable LED driver circuit of claim 1, characterized in that one input terminal of the peak current comparator is connected to the current sensing resistor, another input terminal is connected to the reference voltage.

3. The TRIAC dimmable LED driver circuit of claim 1, characterized in that the LED driver circuit further includes an OR logic gate and a RS flip-flop, the input signal of the maximum on-time timer is the output signal of the RS flip-flop, the input signal of the OR logic gate is the output signal of the maximum on-time timer and the output signal of the peak current comparator, the output signal of the OR logic gate is connected to the reset terminal of the RS flip-flop.

4. The TRIAC dimmable LED driver circuit of claim 3, characterized in that the LED driver circuit further includes a first voltage sensing network, a second voltage sensing network and a demagnetization comparator, the input terminal of the first voltage sensing network is connected to the gate of the power MOS transistor, the input terminal of the second voltage sensing network is connected to the source of the power MOS transistor, the output of the first voltage sensing network and the second voltage sensing network are connected to the input terminals of the demagnetization comparator, the output of the demagnetization comparator is connected to the reset terminal of the RS flip-flop.

5. The TRIAC dimmable LED driver circuit of claim 4, characterized in that the first voltage sensing network is composed by resistors and capacitors; and the second voltage sensing network is composed by resistor and capacitors.

6. The TRIAC dimmable LED driver circuit of claim 3, characterized in that the LED driver further includes a switch driver, the input terminal of the switch driver is connected to the output of the RS flip-flop, the output of the switch driver is connected to the gate of the low voltage MOS transistor.

7. The TRIAC dimmable LED driver circuit of claim 1, characterized in that the inductor or the transformer includes at least two windings, the first winding is connected to the power MOS transistor, the auxiliary winding is connected to the positive terminal of a supplying diode, the negative terminal of the supplying diode is connected to a supplying capacitor.

8. The TRIAC dimmable LED driver circuit of claim 7, characterized in that the LED driver further includes two resistors and an over voltage protection circuit, the resistors are in series and are connected to the auxiliary winding of the inductor or transformer, the middle point of the resistors is connected to the over voltage protection circuit.

9. The TRIAC dimmable LED driver circuit of claim 7, characterized in that the supplying capacitor is paralleled with a zener diode.

10. The TRIAC dimmable LED driver circuit of claim 1, characterized in that the LED driver is one of a buck-boost TRIAC dimmable LED driver, a buck TRIAC dimmable LED driver, or a flyback TRIAC dimmable LED driver.
